(19) United States
(12) Patent Application Publication
(10) Pub. No.: US 2011/0072340 A1
(43) Pub. Date: Mar. 24, 2011

(54) MODELING SYSTEM AND METHOD

(76) Inventors: Darren H. Miller, Bellevue Hill (AU); Gary M. Miller, North Bondi (AU)

(21) Appl. No.: 12/886,420

(22) Filed: Sep. 20, 2010

(30) Foreign Application Priority Data
Sep. 21, 2009 (AU) 2009904567

(51) Int. Cl. G06F 17/00

(52) U.S. Cl. 715/220

(57) ABSTRACT

Methods and devices are provided for assigning cell properties based on user-defined metadata in a spreadsheet. In one embodiment, the method may involve receiving at least one row metadata and at least one column metadata. The method may involve associating cells at an intersection of at least one row containing the at least one row metadata and at least one column containing the at least one column metadata into a set. The method may involve assigning at least one property (e.g., formatting attribute and/or content) for the set. In related aspects, the method may further involve, in response to a user changing the at least one property in any cell of the set, applying the changed at least one property to each cell of the set.

### CLAIM OF PRIORITY UNDER 35 U.S.C. §119

The present application for patent claims priority to Australian Provisional Application No. 2009904567, entitled “Modeling System,” filed Sep. 21, 2009, and is assigned to the assignee hereof, and is hereby expressly incorporated in its entirety by reference herein.

### BACKGROUND

1. Field

The present application relates generally to a modeling system, and more particularly to a computer-implemented, spreadsheet modeling system that is suitable for constructing data models of real-world phenomena.

2. Background

Computer spreadsheets were developed around the late 1970s and early 1980s to run on personal computers. These first spreadsheets were an electronic replication of paper-based documents commonly used by accountants and bookkeepers, but with a number of advantages over those documents. Most significantly, they provided the ability to create formulae or algorithms based on input data that, when changed by the user, caused the spreadsheet to recalculate its formulae. This process of changing input values and observing the impact this had on key results or outputs became known as “what-if” analysis. This functionality was one of the key advances and benefits introduced by spreadsheets.

For many years spreadsheets consisted of a simple two-dimensional grid or matrix of cells, with each of these cells identified by a unique row and column reference using a predefined notation. In the most common notation, columns are referred to by letters starting from “A”, and rows are referred to by numbers starting from “1”. These spreadsheets were implemented in software that was installed and run on localized personal computers.

Recently a new type of spreadsheet application, called online spreadsheets, has emerged and is gaining support from users around the world. They offer similar functionality to localized spreadsheets, but provide this functionality via a web browser. Some of the advantages of these online spreadsheets include multi-user collaboration and online storage.

Spreadsheets are used on a daily basis by tens of millions of individuals, businesses, governments and other organizations worldwide. So pervasive are they that spreadsheets have become a fundamental tool in the functioning of world commerce.

One of the reasons that spreadsheets have been so successful and widely used is that they are simple to comprehend and easy to use, even for novices. They require and assume no knowledge of computer programming, mathematics, finance, or any other scientific discipline. Users are presented with a blank grid and a highly visual and inviting interface. And, without the need for any configuration or education, users are able to start entering input data, formulae, and the like. Not only is the interaction with spreadsheets intuitive, but users are provided with immediate feedback in the form of results. There is no waiting for the program to compile or pages to be printed out. The results of their data and formula entry are immediately visually discernable on the computer screen. It is this positive feedback loop that encourages the user to go further and build ever more complexity into their analysis. Due to their accessibility, spreadsheets exist mainly in the domain of end users, not the information technology (IT) department.

This openness and accessibility to vast numbers of end users who do not have formal IT training or scientific background is a big reason for spreadsheets' success but also a cause of problems. Some of the problems associated with traditional spreadsheets, and their use, include:

complexity—spreadsheets start out simple but can quickly get very complicated, with a web of cells and formulae that link together in complex ways.

inflexibility—once a spreadsheet has been created, including elements of logic, input, output, formatting, etc., it is very difficult to make structural changes to the model because seemingly insignificant changes can have unintended flow-on effects to other cells in the spreadsheet.

difficulty in verification and auditing—it is notoriously difficult to audit a spreadsheet for correctness. Every formula should be reviewed, understood, traced back to the cells it depends on, and assessed for correctness. Cells are discrete entities and even groups of logically identical cells still need to be checked for consistency. Furthermore, the cell references themselves are one step removed from underlying logic and meaning, and need to be interpreted by a human and mapped to something that they can comprehend. For example, to be properly understood, the spreadsheet formula=SUM(X31:X50) first needs to be interpreted by a human (e.g., “the sum of all the revenue items”).

documentation—most users do not document their spreadsheets. This makes it very difficult for other users (or even for the creator of the spreadsheet when viewing their model later) to understand what the spreadsheet model does, how to use it, and how to ensure that it remains accurate.

lack of reusable components—partly because of the problem of growing complexity identified above, but mainly due to the nature of the technology itself, new spreadsheets are generally commenced from scratch with very little reuse of elements from older spreadsheets.

copy and paste—spreadsheet cells are individual entities and there is no suitable method for multiple cells to share or inherit the same underlying logic. As a result, users often copy a formula from one or more cells and paste this formula to other cells which the user desires to share the same underlying logic. This is inconvenient, intricate, and a source of errors, as the spreadsheet does not maintain the consistency of the formulae in these physically separate but logically similar cells.

A model can be thought of as “a simplified representation of reality”, and financial modeling can be defined as “the task of building an abstract representation (a model) of a financial decision making situation.” Typically this involves using a computer to record a set of inputs and algorithms (or calculations) to produce a set of desired financial outputs which are of interest to the user. Financial modeling is used in various commercial disciplines including: business valuation, financial analysis, investment decisions, and the like. Financial modeling is a critically important activity in modern business, and skill in financial modeling can form a major part of an organization's strategic advantage. Likewise, non-existent or poor financial modeling can cause an organization to fail.

Traditional spreadsheets are the predominant tool or technology used to create financial models. Despite the disadvantages of traditional spreadsheets discussed above, they continue to prevail as the tool of choice. Accordingly, there is a need for a spreadsheet-based modeling system that overcomes the above-described disadvantages of traditional spreadsheets.

### SUMMARY

In accordance with one or more embodiments and corresponding disclosure thereof, various aspects are described in connection with a method performed by a computing device, processor, or network entity. The method may relate to assigning cell properties based on user-defined metadata in a spreadsheet. The method may involve receiving at least one row metadata (e.g., a keyword, a tag, a label, and/or a row hierarchical position), and receiving at least one column metadata (e.g., a keyword, a tag, a label, and/or a column hierarchical position). The method may involve associating cells at an intersection of at least one row containing the at least one row metadata and at least one column containing the at least one column metadata into a set. The method may further involve assigning at least one property for the set.

In related aspects, assigning the at least one property may involve assigning a formatting attribute to each cell of the set. In the alternative, or in addition, assigning the at least one property may involve assigning same content (e.g., a formula, a numerical value, and/or a string) to each cell of the set.

In further related aspects, the method may involve, in response to a user changing the at least one property in any cell of the set, applying the changed at least property (e.g., content and/or formatting) to each cell of the set.

In yet further related aspects, the row hierarchical position may comprise at least one of parent status, child status, sibling status, and descendant status, relative to at least one other row of the spreadsheet. Similarly, the column hierarchical position may comprise at least one of parent status, child status, sibling status, and descendant status, relative to at least one other column of the spreadsheet.

In still further related aspects, one or more computing devices may be configured to execute the above described methodology. For example, there is provided an apparatus having at least one processor for executing computer executable instructions, and at least one memory in operative communication with the at least one processor and storing computer executable instructions. The stored computer executable instructions may relate to: receiving at least one row metadata; receiving at least one column metadata; associating cells at an intersection of at least one row containing the at least one row metadata and at least one column containing the at least one column metadata into a set; and assigning at least one property for the set.

According to one aspect of the embodiments described herein, there is provided a software product comprising: a spreadsheet application; an input module adapted to receive one or more user-defined metadata items, each item being applicable to one or more rows or one or more columns of a spreadsheet defined by the spreadsheet application; and a grouping module configured to associate, in response to a user selection of a row metadata item and a column metadata item, spreadsheet cells into sets, the set comprising cells located at the intersection of rows and columns having common metadata items to the selected metadata items.

Described herein is a modeling system that combines beneficial features of spreadsheets for modeling applications, whilst ameliorating some of the limitations of spreadsheets discussed above. In particular, the system allows for spreadsheet cells to be associated into logically meaningful sets for purposes including the application of common formulae and formatting properties, and the improved ability to quickly and easily modify parts of the model structure.

Cells may be associated into sets on the basis of user-defined metadata applicable to rows and columns of the spreadsheet. As metadata is defined by a user to describe data that is resident in the applicable row or column, sets of spreadsheet cells automatically encapsulate logical relationships from the underlying phenomena being modeled.

Typically, the spreadsheet application is configured to enable labeling and positioning of rows and columns in a hierarchical structure, wherein such structured metadata items are descriptive of the position of a row/column within the hierarchy.

Furthermore, the spreadsheet application allows the user to assign unstructured metadata in the form of keywords or tags to one or more rows or one or more columns. This metadata is also descriptive of the nature of the data contained in the applicable rows or columns.

In related aspects, metadata items, in the form of keywords or tags, may be associated into sets of metadata items. The grouping module may be further configured to associate cells into Formula sets, wherein each cell in the set has common user-specified contents (i.e., text, data value, or formula) and Input sets wherein each cell in the set may hold different user-specified contents (i.e., text, value, or formula) to the other cells in the set. Furthermore, both Formula sets and Input sets enable cells within a set to share other properties such as formatting properties (font color, number style, etc.), validation settings, and the like.

It is noted that the grouping module may be further configured to associate cells into sets combining two or more existing sets. In circumstances where two or more sets have been combined into a single joined set, the grouping module may be configured to enable the user to specify which set's properties may be incorporated in the joined set.

The software product may further include a conflict resolution module, said module including routines for associating a cell into a selected set in the event of a cell being logically associable into two or more sets. The routine may select a set according to any suitable criteria. For example, a cell may be associated into a set on a temporal basis, in that a cell is associated into the most recently defined logically associable set. Furthermore, a module is provided to enable the user to change the order of precedence for resolving such conflicts.

The software product may include user interface software configured to visually indicate relevant cells as belonging to a particular set. For example, the user interface may be configured to display the cells of each set in a different color, or to indicate, by way of highlighting, all cells of a set when any cell in the set is selected by the user.

In related aspects, the user interface may display lists of metadata items to facilitate user selection. In one embodiment, the software product may be adapted to execute in a web browser that is communicatively coupled to a server.

According to another aspect of the embodiments described herein, there is provided a spreadsheet modeling method comprising the steps of: receiving one or more user-defined metadata items, each item being applicable to one or more rows or one or more columns of a spreadsheet defined by a spreadsheet application; and associating, in response to a user selection of a row metadata item and a column metadata item, spreadsheet cells into sets, the set comprising cells located at the intersection of rows and columns having common metadata items to the selected metadata items.

To the accomplishment of the foregoing and related ends, one or more aspects comprise the features hereinafter fully described and particularly pointed out in the claims. The following description and the annexed drawings set forth in detail certain illustrative aspects and are indicative of but a few of the various ways in which the principles of the aspects may be employed. Other novel features will become apparent from the following detailed description when considered in conjunction with the drawings and the disclosed aspects are intended to include all such aspects and their equivalents

### BRIEF DESCRIPTION OF THE DRAWINGS

FIG. 1 is a block diagram of the top level components of a software product in accordance with an embodiment of the present invention.

FIG. 2 is an object Model diagram of a model component illustrated in FIG. 1.

FIG. 3 is a Class diagram of a Group component illustrated in FIG. 2.

FIGS. 4-27 are screen shots generated from a software product in accordance with an embodiment of the present invention.

FIG. 28 illustrates an example methodology for assigning cell properties based on user-defined metadata in a spreadsheet.

FIG. 29 shows further aspects of the methodology of FIG. 28.

FIG. 30 illustrates an exemplary apparatus for assigning cell properties based on user-defined metadata in a spreadsheet.

FIG. 31 shows further aspects of the apparatus of FIG. 30.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) can be practiced without these specific details. In other instances, well-known structures and devices are shown in block diagram form in order to facilitate describing one or more embodiments.

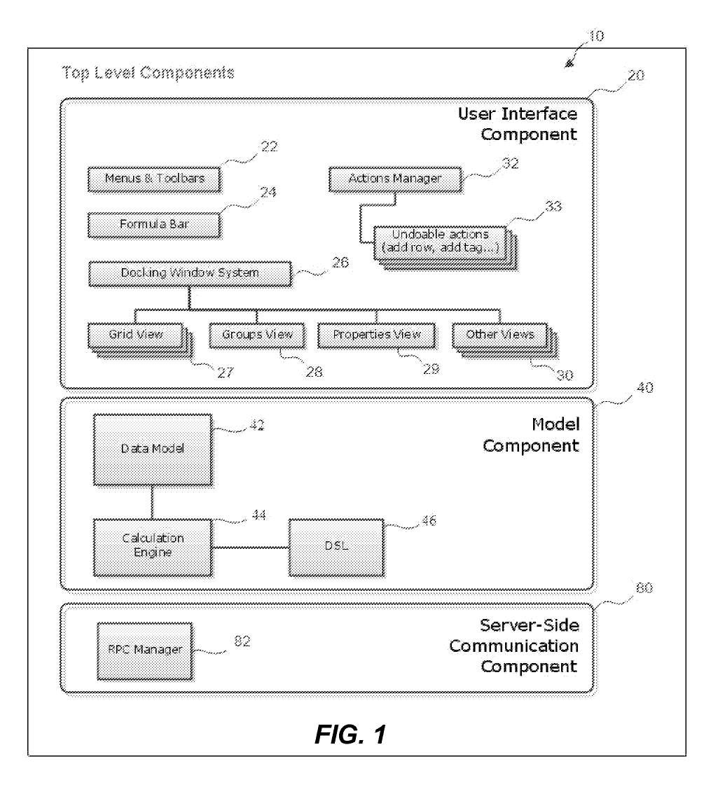

An exemplary software product 10 is illustrated by reference to FIG. 1. The software product 10 comprises a user interface component 20, a model component 40 and a server-side communication component 80. The software product 10 is implemented in Java® using the Google Web Toolkit for the web 2.0 environment. However, as known to those skilled in the art, the software product 10 could be implemented in any other suitable programming language for execution on a desired platform.

The user interface 20 comprises modules for implementing a user interface that presents a familiar spreadsheet grid or matrix to users. In particular, the user interface includes modules for displaying menus and toolbars 22 and a formula bar 24. The user interface 20 also includes a docking window system module 26 for presenting windows of the user interface 20 to users in various views. The docking window system module 26 includes sub-modules for presenting the user interface 20 in a grid view 27, groups view 28, properties view 29 and other views 30. The various views are discussed in greater detail below.

The user interface 20 further includes an actions manager module 32 for capturing and processing user interactions with the user interface 20. As described in greater detail below, an undoable actions sub-module 33 is provided for processing certain undoable actions, such as adding rows or tags to spreadsheets created by way of the software product 10.

A model component 40 includes a data model object 42 for enabling manipulation of the various objects comprising the software product 10. A calculation engine 44 is implemented as a separate object to the data model object 42 and includes a domain specific language (or DSL) specification 46 which provides a defined syntax and method for users to refer to model data and formulas available in the software product 10.

The software product 10 is deployed on a suitable web server (not shown) to enable creation of distributed spreadsheets that are accessible to multiple remote users via general purpose web browsers. The server-side communications module 80 includes a remote procedure call manager 82 for implementing such functionality.

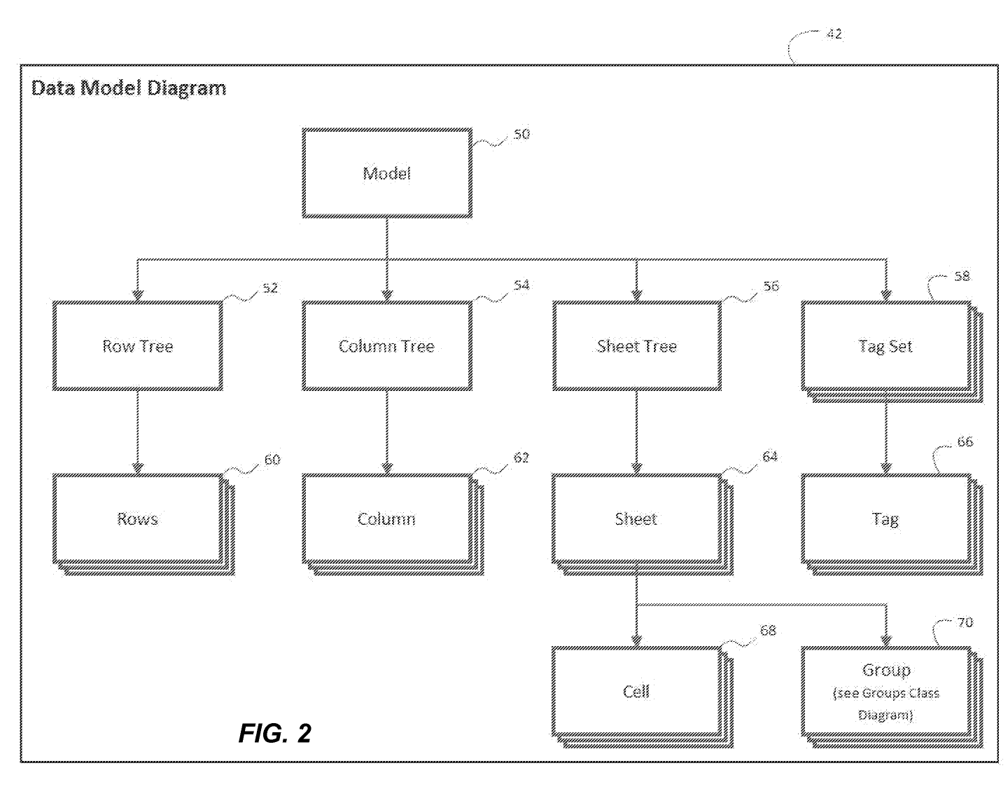

An object model diagram of the data model object 42 is shown in FIG. 2. The data model object 42 comprises a model object 50, which in turn includes a row tree object 52, a column tree object 54, a sheet tree object 56, and a tag set objects 58. The row tree object 52 includes one or more rows 60, the column tree object 54 includes one or more columns 62, the sheet tree object 56 includes one or more sheets 64, and each tag set object 58 may include one or more tags 66. Each sheet contains one or more cells 68, each of which represents the intersection of a row and a column, for that sheet. Each sheet may also contain one or more groups 70.

The tag sets 58 are sets of user-defined keywords or tags 66 that describe the data that is present in a particular row 60 or column 62. As discussed in detail in the example below columns of a spreadsheet labeled with the months of a year can be assigned a tag of Month. Likewise, columns of a spreadsheet labeled as Q1, Q2, Q3 or Q4 can be assigned a tag of Quarter. Cell objects 68 are familiar spreadsheet cells that exist in the sheets 64.

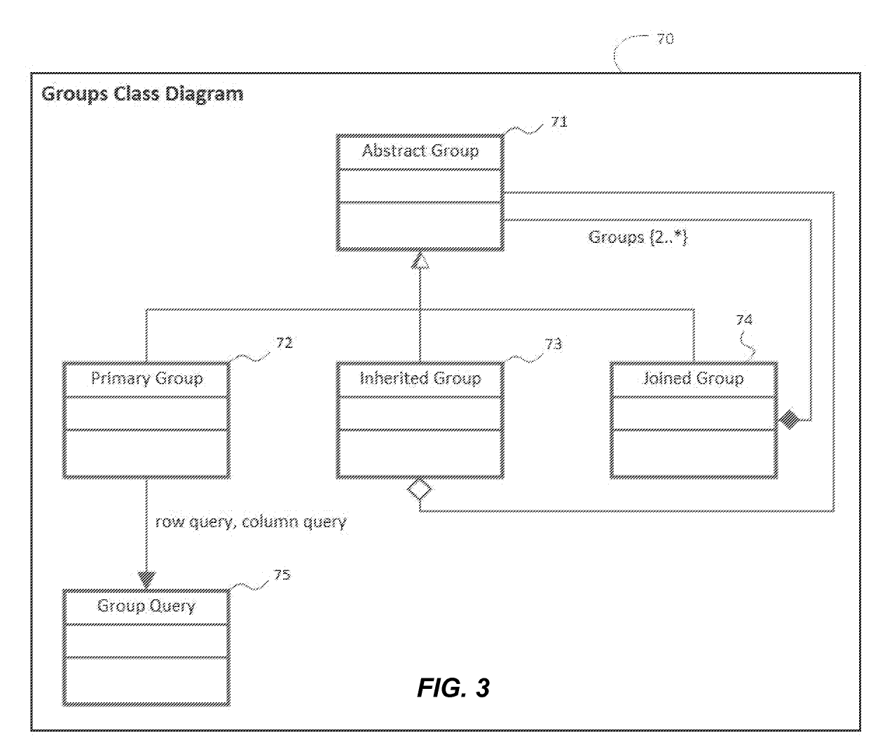

Each sheet object 64 may include Group objects 70 which are sets of cells associated into groups by the software product 10 on the basis of selected metadata. A Class diagram of Groups objects 70 is provided in FIG. 3. Groups 71 are either primary Groups 72, inherited Groups 73 or joined Groups 74. As discussed in greater detail below, primary Groups 72 comprise sets of cells that are logically associated with one another in a user-defined way. Logical relationships between the cells of a primary Group 72 are a function of the particular real-world phenomena being modeled in the software product 10. Cells are automatically associated into Groups by the software product 10 on the basis of user-defined metadata and the user specifying one or more elements of row metadata and one or more elements of column metadata. A cell can only exist within one Group at a time. In the case of a conflict (i.e., where a cell could potentially fulfill the criteria for inclusion in more than one Group) a suitable conflict resolution routine is applied, as discussed in greater detail below.

Inherited Groups 73 are Groups that refer to another Group in the direct chain above it in the sheet tree. Cells are associated into primary and inherited Groups by the software product 10 through issuing of suitable queries 75. Group queries are executed on the basis of searches for rows and columns having a specified pattern within the sheet that the Group exists. Joined Groups 74 are Groups that are formed from two or more other Groups in the same sheet.

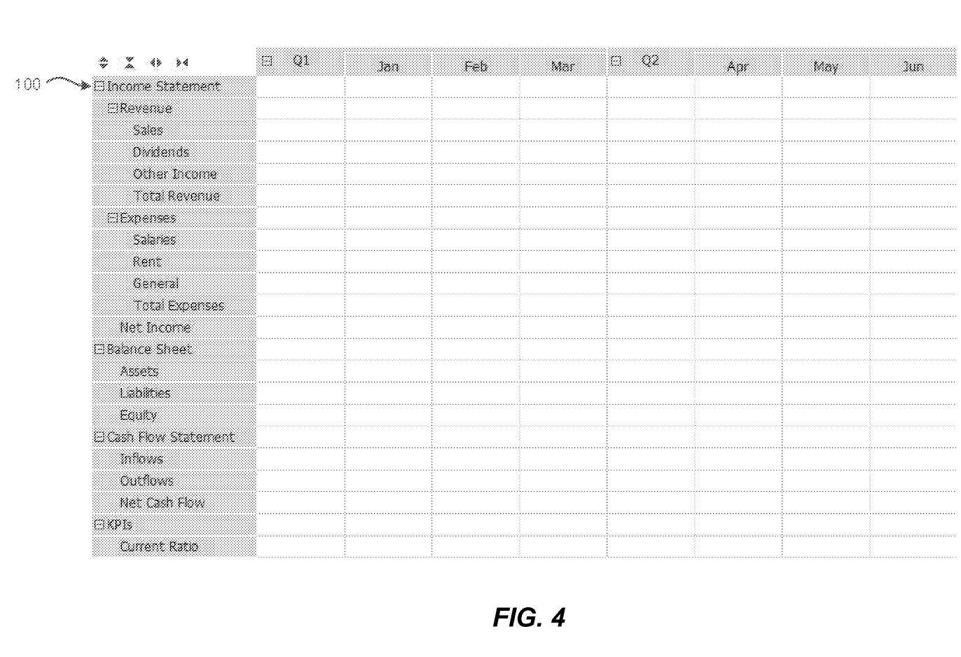

Turning to FIG. 4, an example display generated by the user interface 20 is shown. Rows and columns are structured in a tree formation which is both easy to navigate through and also provides a meaningful structure to row and column labels. The part of the grid that is visible includes data indicative of financial statements, such as income statement, balance sheet, cash flow statement, KPIs (key performance indicators), etc.

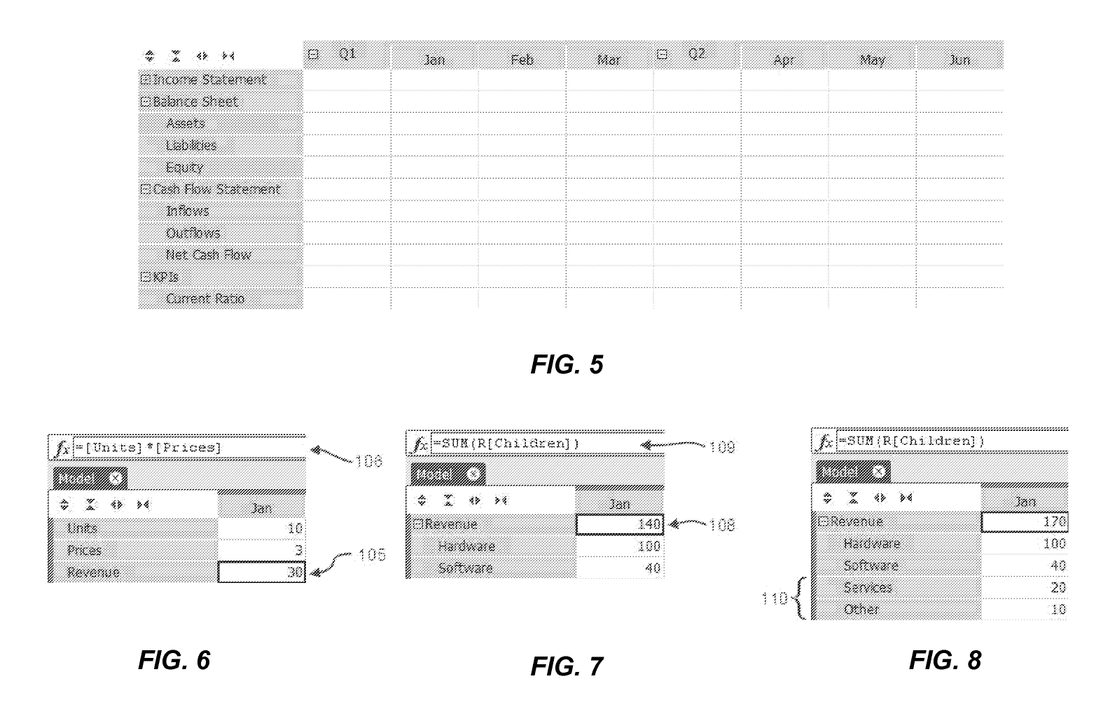

The tree display for rows and columns allows the user to quickly collapse or expand whole sections of a model with a simple mouse click or keystroke combination. For example, clicking the minus sign to the left of the Income Statement row label 100 immediately collapses all the items nested underneath this row to yield the display shown in FIG. 5.

Row and column trees are inherently part of the model structure. A user is able to quickly and easily cause rows to be nested left or right, and columns to be nested up and down, in order to convey the intended model structure. Once the structure has been established the user can collapse and expand individual rows and columns or sections of the model, collapse the whole model, expand the whole model and the like. In turn, this enables convenient and powerful navigation through the grid. The hierarchical structure for rows and columns is useful and helpful for referencing cells, and for defining cell sets or groups, as discussed further below.

Although user interface 20 displays a spreadsheet-like grid, there are no traditional cell references. Instead, cells are referenced by user-defined row and column labels which are exactly what the user sees in the grid, as shown in FIG. 6. With continued reference to FIG. 6, the cell 105 at the intersection of the Revenue row and the January column is selected. The formula entered in this cell is shown in the box to the right of the fx symbol 106. This formula=[Units]*[Prices] is effectively saying “the cell (in this column) in the Units row multiplied by the cell (in this column) in the Prices row.” If the row label Units is changed to say Quantity, the formula would automatically change to =[Quantity]*[Prices].

Such native language referencing brings many benefits as may be apparent to a skilled addressee. Formulae are easier to write and understand; when one reads the formula=[Units]*[Prices], it is immediately understood what is being said and it can be mentally agreed that the logic is sound. In contrast, a traditional spreadsheet formula of =B2*B3 requires a user/reviewer to first identify what rows 2 and 3 are, and then translate the coded reference into something that is meaningful to a human.

As discussed above, row and column structure (i.e., tree hierarchy) can be used for referencing cells and also for creating Cell Groups or sets (which are discussed in detail below). The example shown in FIG. 7 shows how row and column structure can be used to reference cells in formula notation. As will be apparent to those skilled in the art, the cell 108 at the intersection of the Revenue row and the January column is selected, and the formula=SUM(R[Children]) entered in cell 108 (this is shown in the formula editor 109).

This formula in formula editor 109 in notation effectively means “the sum of my children rows”. Since the Revenue row has two children: Hardware and Software, the formula is adding up the values in these rows for the current column (i.e., 100+40=140).

As further children rows are added below Revenue, as shown in FIG. 8, the formula automatically includes the new rows (based on their structural position as children of Revenue) in the total. It will be apparent that two new rows 110 (Services and Other) have been added as children of Revenue. The formula (which refers to the children of the current row) has automatically included the values in these new rows in the total (now equaling “170”).

The syntax of the embodiments described herein may include the following keywords which a user can use to reference the hierarchical structure of rows and columns: Children, Siblings, Parent, All, This, Descendants, and Ancestors. It will be apparent that all of these keywords (other than This) can apply to either the row structure or the column structure. As such one should specify, using the prefix R or C, whether the keyword is to apply to structure in the rows or the columns.

One feature of the modeling system described herein is the ability to construct cell sets or groups (hereafter referred to as Cell Groups or Groups). Simply, a Cell Group is a Group of cells that are logically associated with one another in a user-defined way.

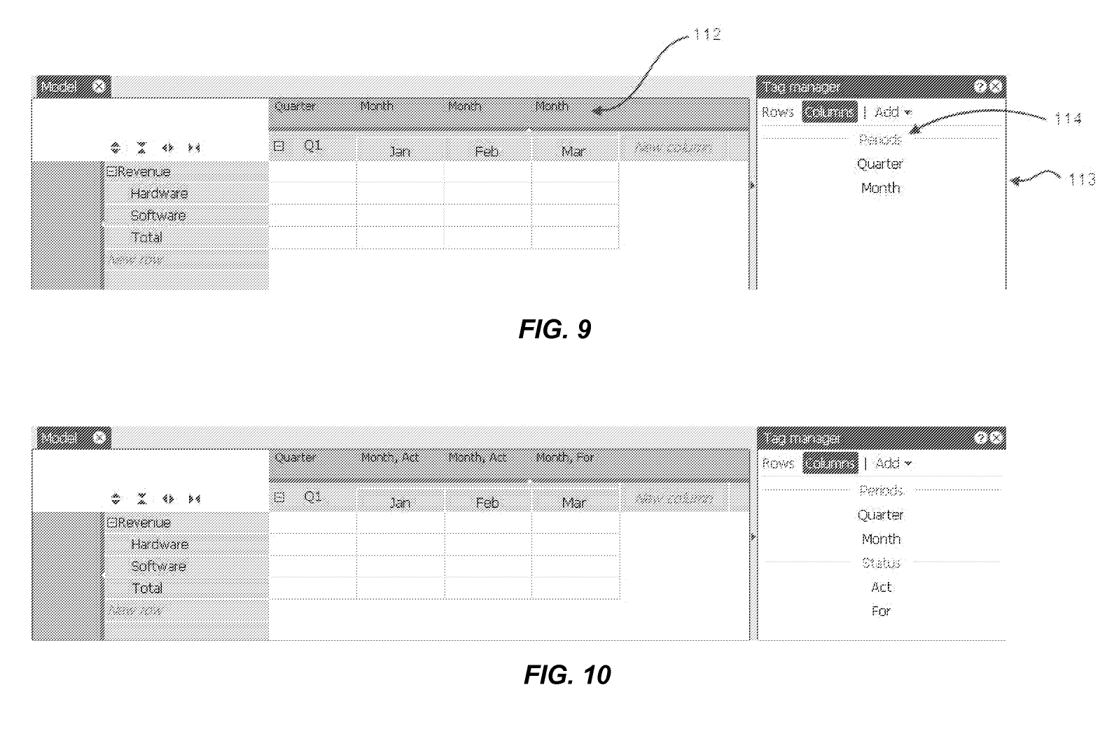

Before describing Groups in detail and how they may be advantageously deployed, it is first necessary to discuss another type of row and column metadata, in the form of user-defined keywords or tags which describe characteristic(s) about the rows and columns. Referring to FIG. 9, the columns January, February and March are each months, and have been tagged by a user as Months. Likewise, the Q1 column has been tagged as a Quarter. The tags given to each column are displayed in the region 112 above the column labels. As indicated in the Tag Manager panel 113, these tags are all part of a user-defined set of tags named “Periods” 114.

Multiple tags may be assigned to each column and row. For example, January and February could represent actual historical data, whereas March could represent forecast data. A user may wish to type actual values for revenue for the historical months, and a formula to calculate the future revenue for the forecast months. In this case the user would create new tags (Act and For) and then apply these tags to the relevant columns, as shown in FIG. 10.

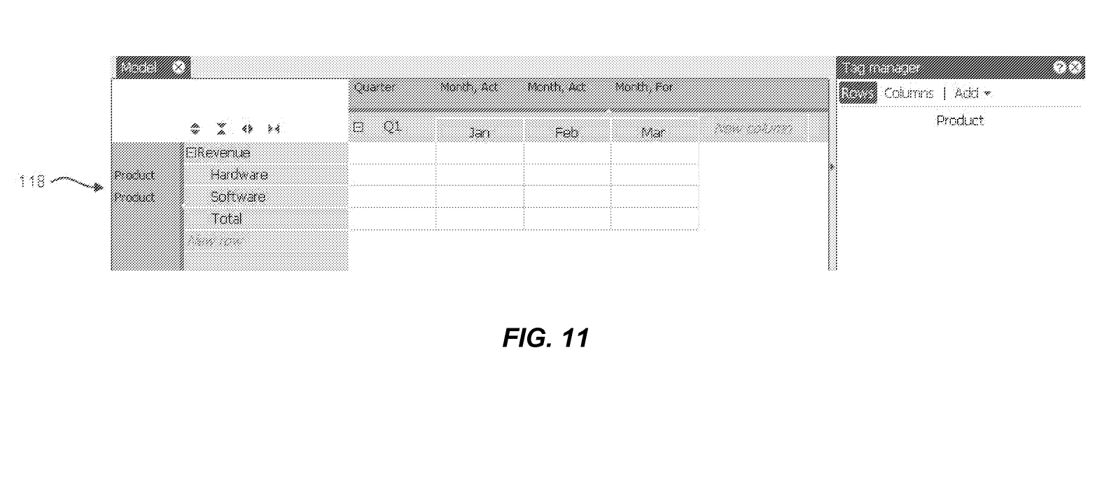

A similar concept is in place for rows. For example, as shown in FIG. 11, the rows Hardware and Software may each be tagged as “Product” 118. As discussed above, a Cell Group is a group of cells that are logically associated with one another. According to an aspect of the embodiments described herein, there are two principal types of Cell Groups—Formula Cell Groups and Input Cell Groups. All cells in a Formula Cell Group have identical user-specified contents (i.e., text, value, or formula). As discussed below, this is useful for certain types of modeling. Input Cell Groups are Groups with cells that can have different user-specified contents.

The cells within a Cell Group share certain properties with one another—for example shading, font color, number format, etc. And, as previously indicated, Formula Cell Groups also share the same user-specified contents. A cell can only exist within (at most) one Cell Group at a time.

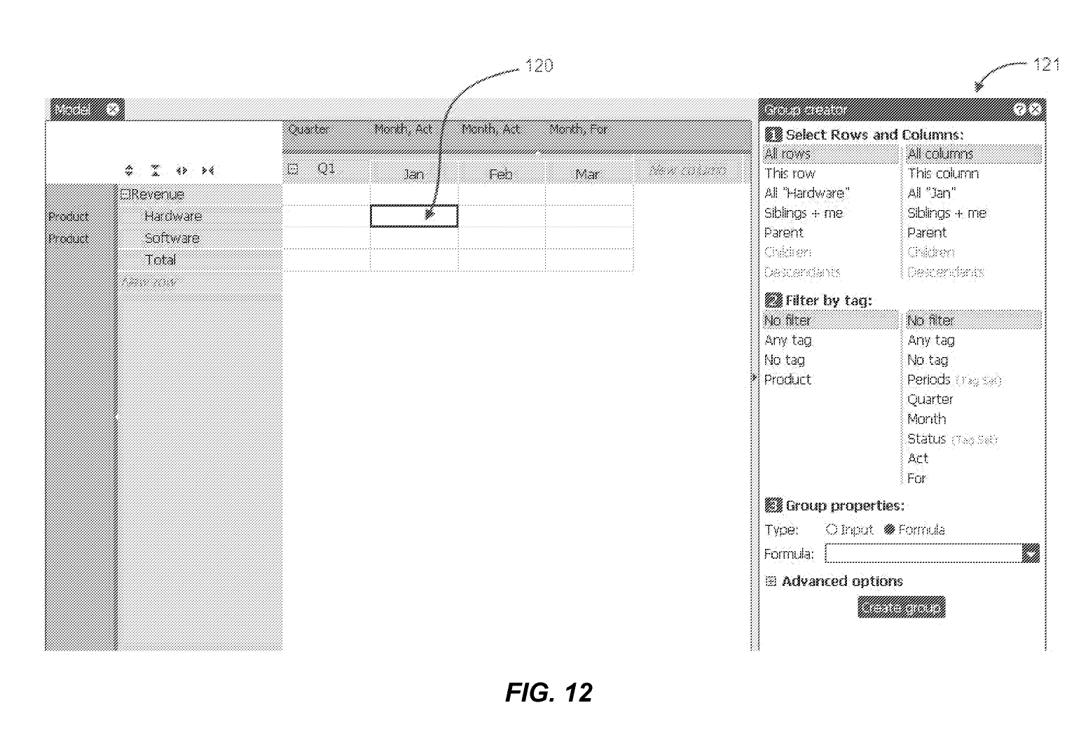

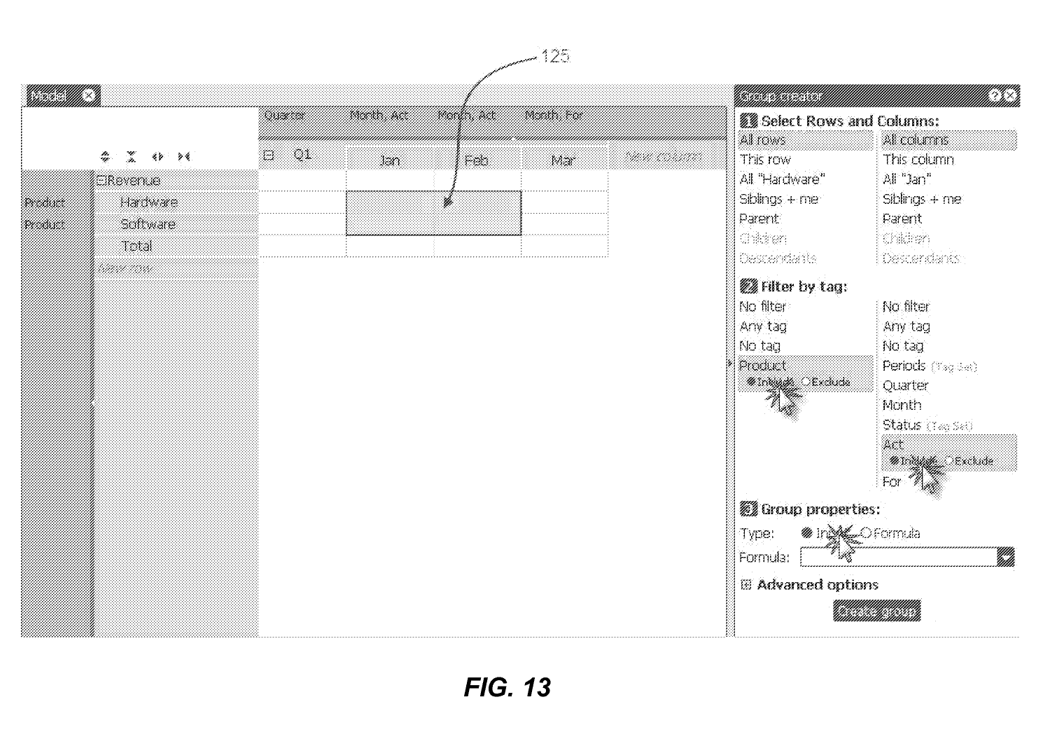

Referring again to FIG. 11, a user may wish to indicate logically and visually that the intersection of the rows tagged Product and the columns tagged Act “belong together”—albeit that they may have different user-specified values. For example, with reference to FIG. 12, the user may select a cell 120 at the intersection of the Hardware row and the January column. The software application then provides lists of possible row and column metadata for this cell, such as, for example, via a Group Creator panel 121. The user selects Product from the left side of the “Filter by tag” section and Act from the right side of the “Filter by tag” section of this panel. With reference to FIG. 13, the cells formed at the intersection of the two metadata selections are then automatically highlighted in a shaded area 125 on the grid.

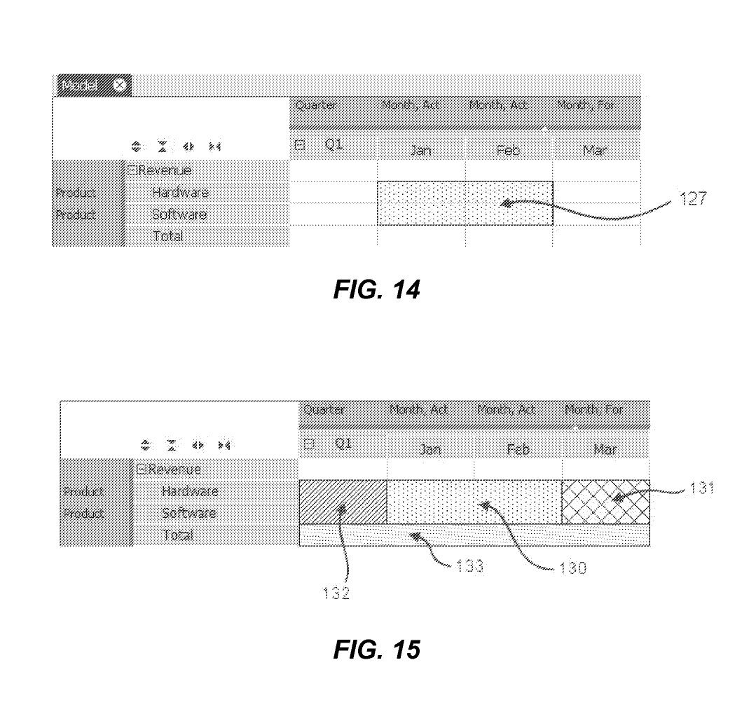

The user then selects the Input option under the “Group properties” section in the Group Creator panel and then clicks the “Create Group” button. An exemplary resulting model after performing this set of actions is shown in FIG. 14. The shaded cells 127 are now part of the same Input Cell Group. The user may start entering values into these cells or proceed to create other Groups. For example, the user may create the following further Cell Groups:

the intersection of Product rows and For columns—as a Formula Cell Group; the intersection of Children of Revenue rows and Quarter columns—as a Formula Cell Group; and
the intersection of the Total row (the row label itself is metadata) and all columns containing a tag in the Periods tag set—as a Formula Cell Group.

The resulting model, at this stage without any further data entered, is shown in FIG. 15, in which the four Cell Groups created are indicated in variously shaded areas. Cell Groups can be created using any item of row metadata and any item of column metadata—that is, combinations of tags, hierarchical structure and/or the individual rows or columns themselves. For example, the four Cell Groups comprise:

a Cell Group 130 formed from the combination of a row tag (Product) and a column tag (Act);

a Cell Group 131 formed from the combination of a row tag (Product) and a column tag (For);

a Cell Group 132 formed from the combination of row structure (Children of Revenue) and a column tag (Quarter); and

a Cell Group 133 formed from the combination an individual row (Total) and all columns with any tag entry in the Periods tag set.

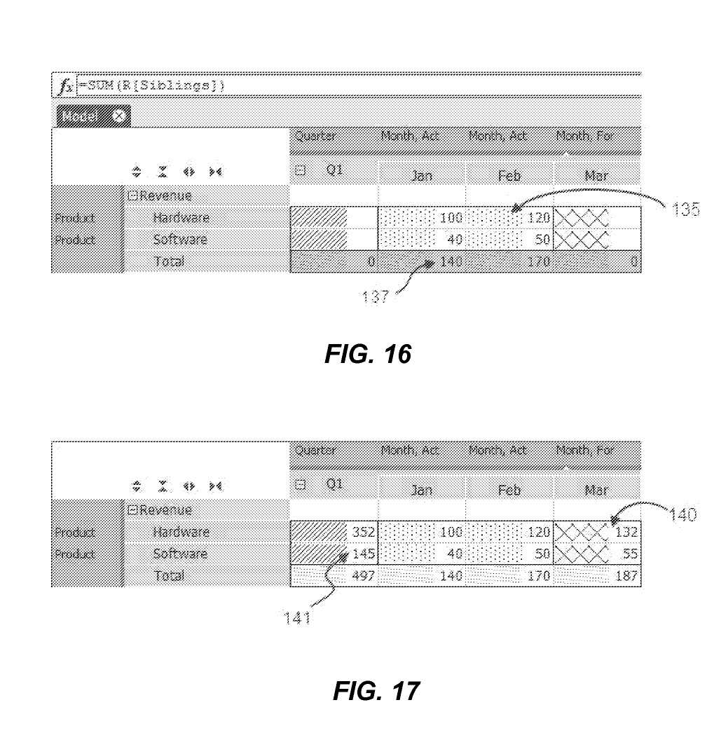

For example, values may then be entered into the Cell Group 135, as shown in FIG. 16. A cell 137 at the intersection of the Total row and the January column may be selected and the formula=SUM(R[Siblings]) may be entered. This formula is in notation and it applies to all cells in the Formula Cell Group. One of the properties of a Formula Cell Group is that all cells in the Group share the same user-specified contents (i.e., text, value, or formula). When a value or formula is entered or edited in one cell of a Formula Cell Group, the contents of all other cells in the Group are updated to the same value or formula. The results of these actions are shown in FIG. 16.

The user may then perform the following actions:

in the cell at the intersection of the Hardware row and the March column 140, enters the formula=[@Month-1]*1.1

in the cell at the intersection of the Software row and the Q1 column 141, enters the formula=SUM(C[Children])

Exemplary results of this are shown in FIG. 17. In this example, only one formula was entered in one cell in each of the Formula Cell Groups, and automatically, all cells in the Group inherited the formula. The key difference between Formula Cell Groups and Input Cell Groups is that cells in a Formula Cell Group all have the exact same user-specified contents, whereas cells in an Input Cell Group may have different contents to one another. When the user-specified contents of any cell in a Formula Cell Group is changed, all cells in the Formula Cell Group are immediately changed to the same user-specified contents. This saves time and also ensures logical consistency.

Although two types of Cell Groups have been disclosed, it should be apparent to a skilled addressee that other types of Cell Groups may be available in the software application. For example, a Cell Group which represents historical actual data and whose cell values should not be changed except by certain authorized users.

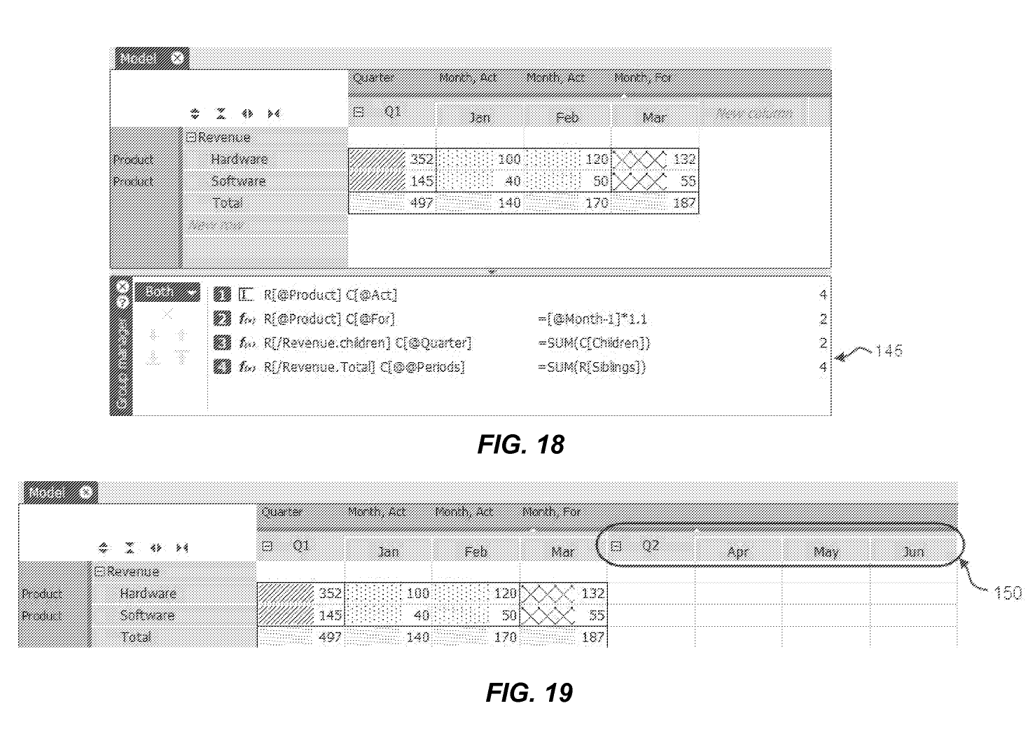

The benefits of Cell Groups include the following aspects. Although there are eight cells containing formulae, there are in reality three unique formulae (one formula for each of the three Formula Cell Groups that were created). Since cells in a Formula Cell Group contain the same user-specified value or formula, in creating the model and then reviewing it later, the user simply needs to input, edit, or check, as the case may be, the formula associated with each Formula Cell Group. The software provides a list of Cell Groups and their properties in a panel below the grid. For example, FIG. 18 shows a Group Manager panel 145, which lists the four Cell Groups created in the example above. The user is able to view and modify the properties of the Cell Groups in their model via this panel.

In traditional spreadsheets, each cell typically exists totally independently of each other cell, and so data entry, editing and reviewing needs to be done on a cell by cell basis. However, the model described herein adjusts automatically for any modifications the user makes to the model in terms of new columns, new rows, changes to column and row tags, and other structural changes. This is demonstrated more fully in the example below.

With reference to FIG. 19, further columns 150 can be added to the model for April, May, June and Q2, as shown in FIG. 19, with the new columns and their labels indicated in the encircled area. As will be apparent to a skilled addressee, the cells in the grid for these columns are blank. This is what would happen in a traditional spreadsheet environment, and it is indeed what happens in the software product for this particular model, since there are no Cell Groups that these cells logically belong to.

However, once tags are applied to these new columns to better describe their properties and purpose, the cells in these columns automatically inherit the properties of the Groups they belong to. So, next, the following tags are applied by the user:

apply the Month tag to April, May and June columns;

apply the For tag to April, May and June columns; and

apply the Quarter tag to Q2.

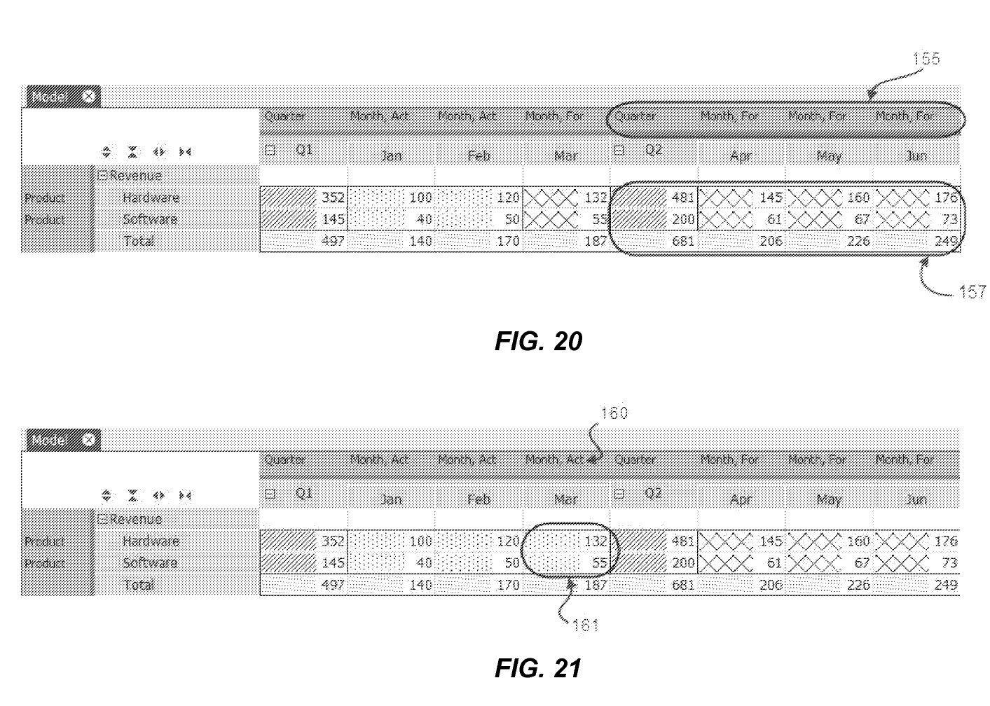

As each of the above steps is completed the model changes and the user interface updates to reflect the previously defined Group structure. Exemplary results are shown in FIG. 20. Area 155 indicates the tags applied as per the steps above, and area 157 indicates the cells that have been updated automatically as a result of these changes. The reason these cells changed is that the model determined that each of these cells were part of previously defined Cell Groups.

Another type of structural change that is frequently used in modeling applications is where forecast data becomes actual data through the effluxion of time. With traditional spreadsheets this process of changing a particular column (e.g., March) from having forecast data to having actual data is difficult. The modeler should ensure that all formulae are correct and should update all values to maintain consistency with the rest of the model. This is known in the art as “rolling the model”, and is often achieved with complex macros. Rolling a model can be time-consuming and is also a leading cause of mistakes and inconsistencies in models.

In contrast, rolling the model is a simple process in the software product according to the techniques described herein. As such, the user can simply modify the appropriate tag. According to the example above, a simple change to the tag for the March column from For to Act suffices, as shown in column 160 of FIG. 21. Comparing FIG. 20 to FIG. 21, the result of this simple process is that the cells in area 161 in FIG. 21 have changed from previously being included in the Formula Cell Group calculating forecast data (see FIG. 20) to now being included in the Input Cell Group reflecting actual historical data, and the user is now able to edit these values independently of one another. It is noted that the user-specified contents may be the same as before, however.

In the described embodiment, cells in Input Cell Groups are indicated in a particular shading, whereas cells in Formula Cell Groups are indicated in another shading. This is advantageous, as Input Cell Groups generally represent input data whereas cells in Formula Cell Groups represent calculations (which in practice are not changed when interacting with a built model, such as, for example, for “what-if” analysis). Alternative shading or colors for Input Cell Groups versus Formula Cell Groups may be selected by the user (such settings being user customizable).

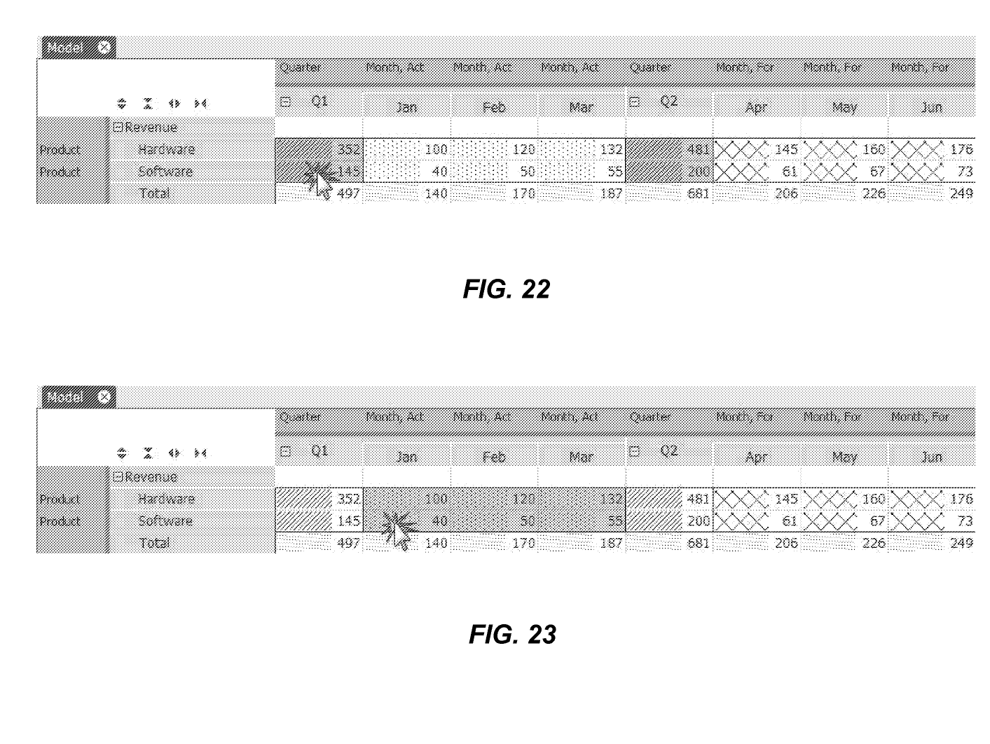

Another notable visual feature of Cell Groups is that when a cell that is part of a Cell Group is selected all other cells in the Group are automatically highlighted. For example, this feature may be enabled by default but can be disabled as a user preference. For example, as shown in FIG. 22, the cell at the intersection of the Software row and the Q1 column is selected and all the cells that are part of this cell's Cell Group are also highlighted (in grey shading)—giving a visual indication of the members of the Cell Group. If the user were now to select the cell immediately to the right of this cell (i.e., the cell at the intersection of the Software row and the January column) the display would immediately change to highlight the cells of this other Cell Group, as shown in FIG. 23. This can serve as a visual cue when dealing with Formula Cell Groups, since a change to one cell affects all other cells in the Group. (The style of highlighting and whether or not this feature is enable or disabled for Formula and/or Input Groups, can be user customizable.)

Another advantage of Cell Groups alluded to above is the ability to format all cells in the Group simultaneously. With traditional spreadsheets, formatting generally occurs on a cell-by-cell basis and users often spend large amounts of time getting the formatting exactly the way they want it. This is effectively wasted time as it does little to further the accuracy or completeness of the model. In fact it can detract from the accuracy of the model since cells with differing logic may be formatted similarly, thereby giving the (misleading) appearance of consistency. Furthermore, in the commercial world people operate under time constraints, and time spent formatting could have been better spent reviewing, testing and documenting the model.

In contrast, the illustrated embodiment of the techniques described herein does not encourage cell-level formatting—but rather uses styles and formatting at the level of the Cell Group.

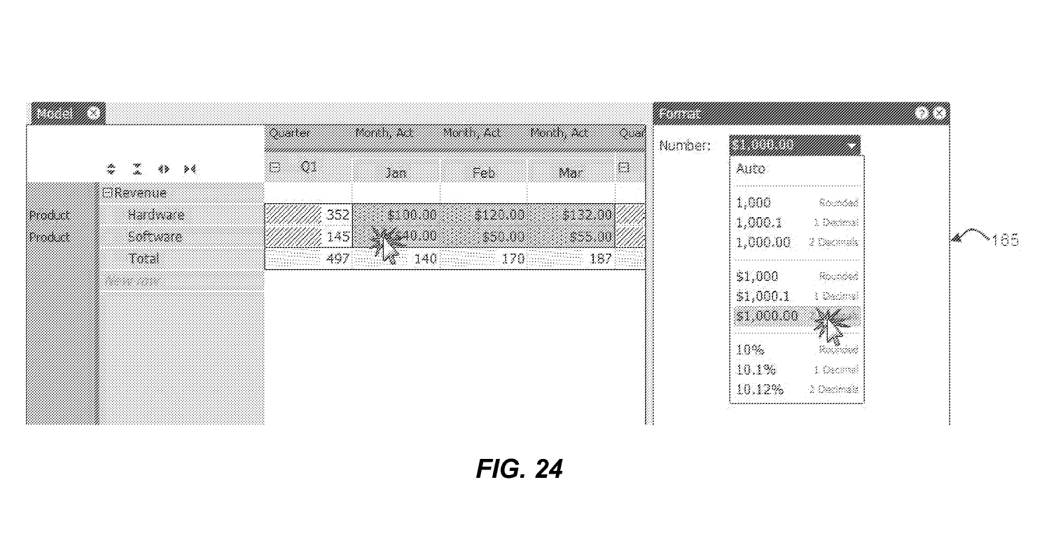

For example, where cells in the Input Cell Group are to be shown with a currency symbol to two decimal places, a single cell in the Cell Group can be selected and the appropriate number format chosen from the drop-down control in the Format panel 165 to the right of the grid. The result of this is that all cells in the Group are formatted with the chosen number format. This is shown in the example of FIG. 24. Although only one cell in this Group was selected, the chosen format is applied to all the cells in the Group. The other Cell Groups can be formatted in the same way. Alternatively, multiple Cell Groups can be selected at the same time (for example, by the user holding down the Ctrl key and then clicking one or more cells in the desired Groups), and then specifying the desired number format.

According to the described embodiment, Cell Groups are created sequentially. The user might early on envisage which Cell Groups they want to create and go about creating them one at a time. Alternatively, they might enter various data (values and formulae) and later decide that certain cells should logically share their properties and so go about creating Cell Groups at this later stage. In both cases, Cell Groups are created one at a time. There is the possibility that conflicts may occur, in that a cell (or multiple cells) may, according to the logical definition of Cell Groups, exist within more than one Cell Group at a time. If allowed to persist, this would cause conflicts which would require the user to decide which Group the cell should get its value and properties from.

This is resolved in the described embodiment by applying a default rule that where a cell could exist in more than one Group, it is taken to exist in the Group that was created more recently. For example, referring back to the logical Cell Groups that were created in the example above, which resulted in FIG. 15—it is apparent that the cell at the intersection of the Total row and the Q1 column is logically incorporated within the areas described by:

Step 3—Cell Group formed from the intersection of Children of Revenue row and a columns tagged Quarter; and

Step 4—Cell Group formed from the intersection of the Total row and all columns with any tag entry in the Periods tag set.

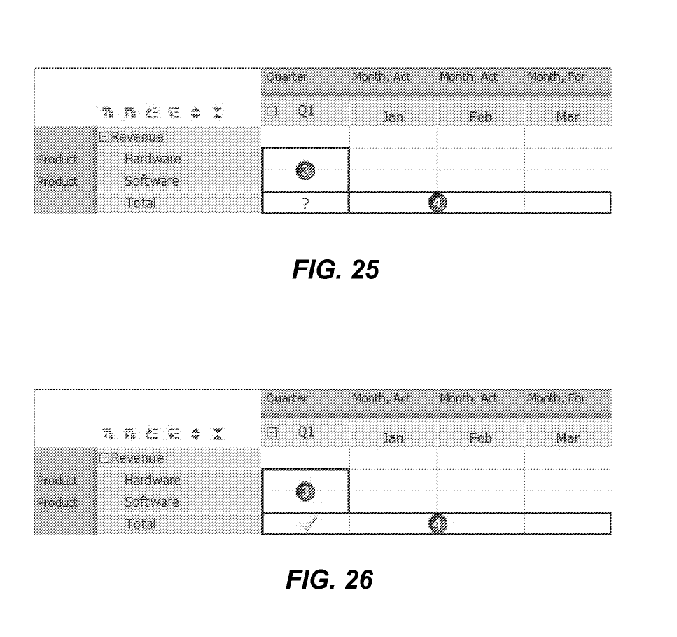

These areas and the resulting overlap (indicated by a question mark) is shown in FIG. 25. It is apparent that the cell at the intersection of the Total row and the Q1 column is incorporated in the logical construction of the Cell Group created at step 3 AND the Cell Group created at step 4. Since a cell can only exist within one Cell Group at a time, as a default condition, it is placed in the Group created more recently (i.e., later in time). In this case, it is the Group created at step 4.

As can be seen in FIG. 26, the cell in question (indicated with a tick) is correctly part of the Cell Group created at step 4. This effectively overwrites the action (for this cell) undertaken at step 3. Another way that Cell Groups can be formed is by joining two or more Cell Groups together. This may be needed where a user wants a range of cells to have the same properties but it is not possible to form this Group by selecting just one element of row metadata and one item of column metadata. In this case it is possible to create one or more Cell Groups and then join these together. When joining two Groups together (say A and B), the user may decide whether the properties (value, formula, number format, etc.) of Group A or B are retained. This is resolved by the user specifying which of Group A or B takes precedence, at the time the Groups are joined.

A further advantage of the techniques described herein over traditional spreadsheets is that the visual display is independent of the model logic and therefore can be changed to suit the user's needs without affecting in any way the workings of the model. For example, you may want to stack the Quarter columns together first, followed by all the Month columns. With traditional spreadsheets this can be difficult, as moving columns around can destroy the formula references unless great care has been taken, for example, by using user-defined names in all formulae, advanced formulae, or defensive techniques that anticipate such changes.

According to the techniques described herein, since formulae refer to purely logical references (e.g., my siblings, my children, the prior month, etc.) rather than physical references (e.g., the 2 rows above me, the 3 columns to my left, etc.), moving columns around does not affect the model logic or the underlying calculations.

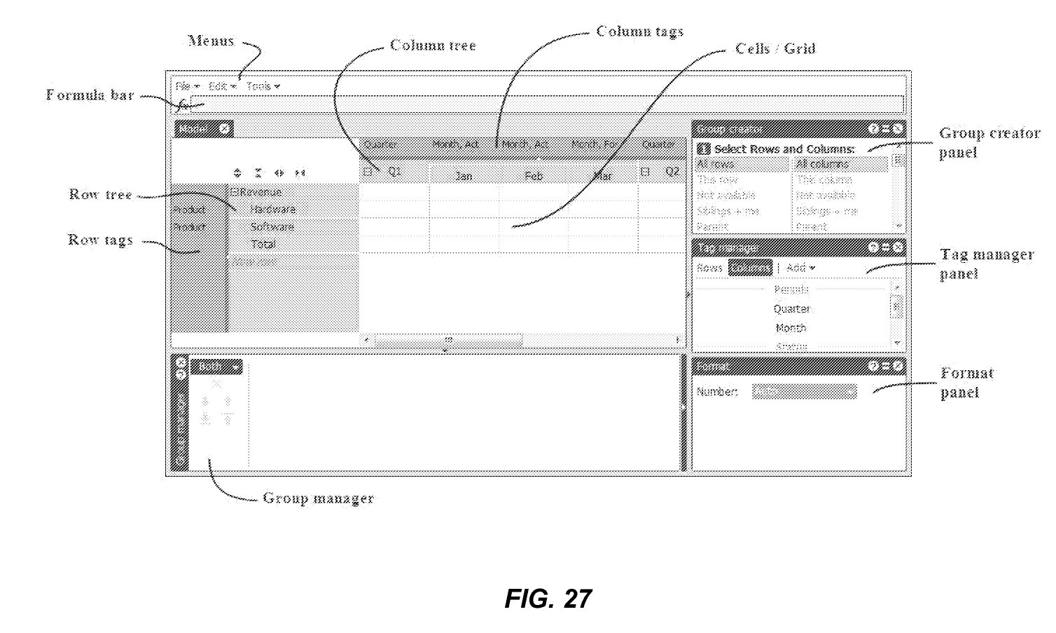

A further advantage of having the model logic separate from the data it contains is that the user is able to define the model logic once, yet assign different values to input cells, as required. For example, the user might want to model various scenarios for forecast revenue. This may be achieved by the user introducing a third axis (i.e., multiple sheets) to the model to allow for certain cells (formed at the intersection of rows and columns) to contain a number of different user-specified contents. An overview of the user interface is shown in FIG. 27, with various user interface components indicated.

In view of exemplary systems shown and described herein, methodologies that may be implemented in accordance with the disclosed subject matter, will be better appreciated with reference to various flow charts. While, for purposes of simplicity of explanation, methodologies are shown and described as a series of acts/blocks, it is to be understood and appreciated that the claimed subject matter is not limited by the number or order of blocks, as some blocks may occur in different orders and/or at substantially the same time with other blocks from what is depicted and described herein. Moreover, not all illustrated blocks may be required to implement methodologies described herein. It is to be appreciated that functionality associated with blocks may be implemented by software, hardware, a combination thereof or any other suitable way (e.g., device, system, process, or component). Additionally, it should be further appreciated that methodologies disclosed throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

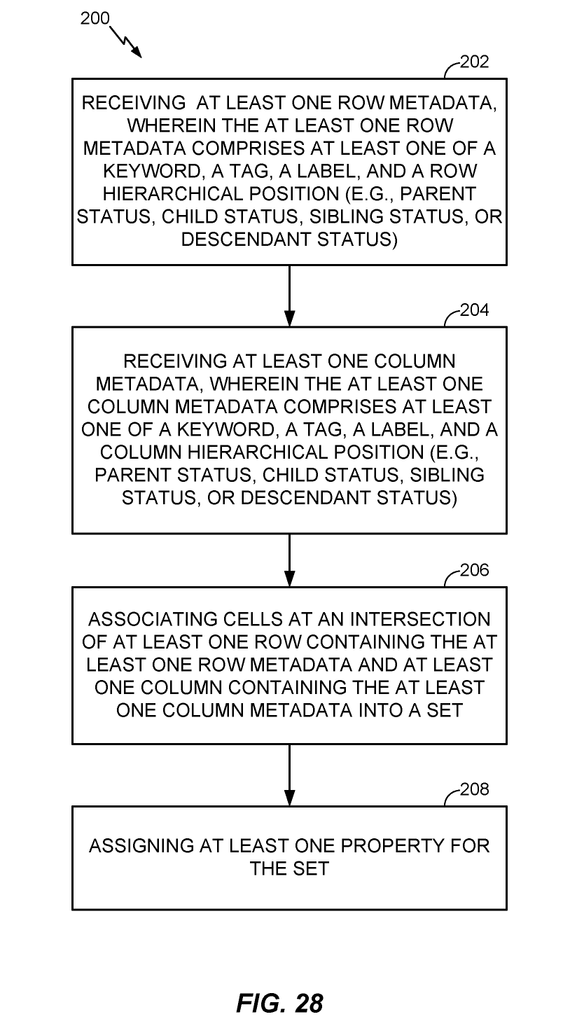

In accordance with one or more aspects of the embodiments described herein, there is provided a method for assigning cell properties based on user-defined metadata in a spreadsheet. With reference to FIG. 28, illustrated is a methodology 200 that may be performed by a computing device. At 202, at least one row metadata is received. At 204, at least one column metadata is received. At 206, the method 200 involves associating cells at an intersection of at least one row containing the at least one row metadata and at least one column containing the at least one column metadata into a set. At 208, at least one property for the set is assigned. It is noted that an intersection of the at least one row and the at least one column may comprise one or a plurality of cells, depending on how many rows (with the at least one row metadata) and how many columns (with the at least one column metadata) intersect with each other. For example, an intersection of one row and one column may include one cell. However, an intersection, of two rows and three columns may include six cells. As such, at 206, a plurality of intersecting cells may be associated into the set.

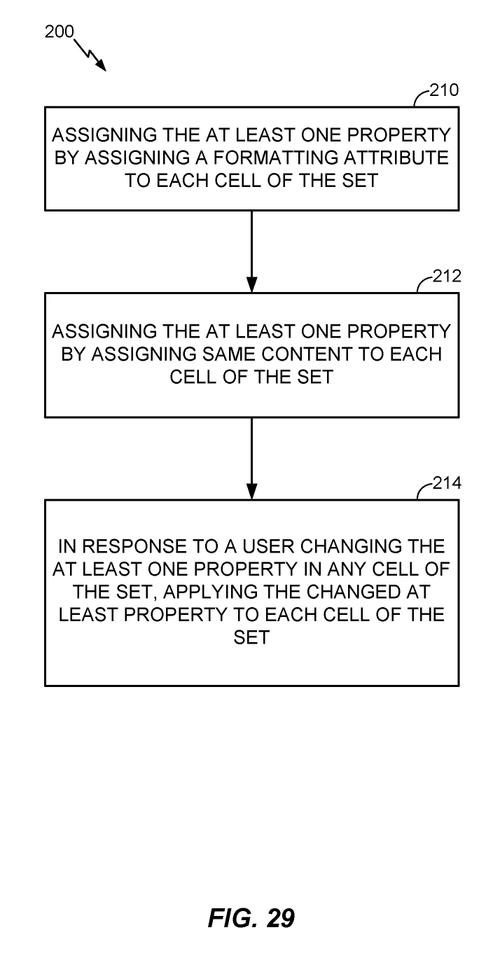

With reference to FIG. 29, assigning the at least one property may involve, at 210, assigning a formatting attribute to each cell of the set. In the alternative, or in addition, assigning the at least one property may involve, at 212, assigning same content to each cell of the set. The method 200 may involve, at 214, in response to a user changing the at least one property in any cell of the set, applying the changed at least one property to each cell of the set.

In related aspects, the at least one row metadata may comprise a keyword, a tag, a label, and/or a row hierarchical position. The row hierarchical position may comprise at least one of parent status, child status, sibling status, and descendent status, relative to at least one other row of the spreadsheet. Similarly, the column hierarchical position may comprise at least one of parent status, child status, sibling status, and descendant status, relative to at least one other column of the spreadsheet.

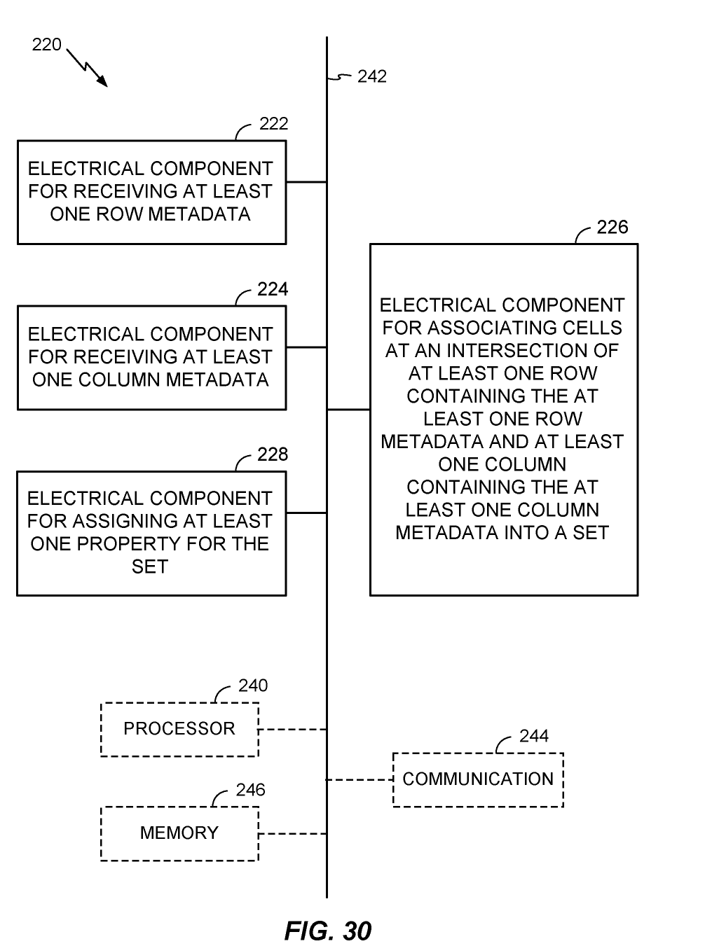

In accordance with one or more aspects of the embodiments described herein, there are provided devices and apparatuses for executing the assigning of cell properties and grouping of cells, as described above with reference to FIGS. 28-29. With reference to FIG. 30, there is provided an exemplary apparatus 220 that may be configured as a computing device, or as a processor or similar device for use within the computing device. The apparatus 220 may include functional blocks that can represent functions implemented by a processor, software, or combination thereof (e.g., firmware).

As illustrated, in one embodiment, the apparatus 220 may comprise an electrical component or module 222 for receiving at least one row metadata. The apparatus 220 may comprise an electrical component 224 for receiving at least one column metadata. The apparatus 220 may comprise an electrical component 226 for associating cells at an intersection of at least one row containing the at least one row metadata and at least one column containing the at least one column metadata into a set. The apparatus 220 may comprise an electrical component 228 for assigning at least one property for the set.

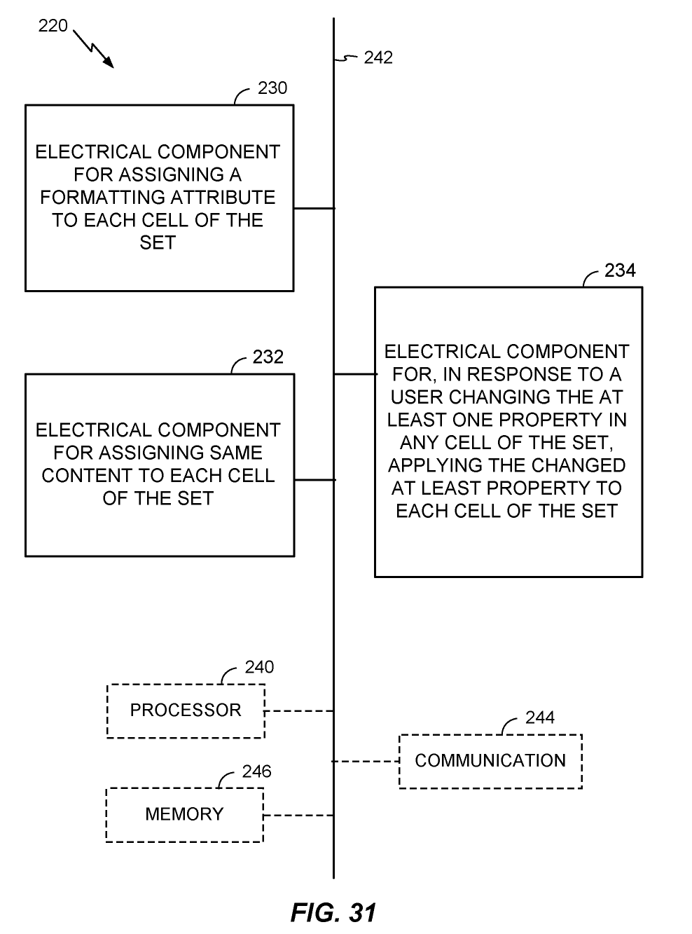

With reference to FIG. 31, the apparatus 220 may comprise an electrical component 230 for assigning a formatting attribute to each cell of the set. The apparatus 220 may comprise an electrical component 232 for assigning same content to each cell of the set. The apparatus 220 may comprise an electrical component 234 for, in response to a user changing the at least one property in any cell of the set, applying the changed at least one property to each cell of the set.

In related aspects, the apparatus 220 may optionally include a processor component 240 having at least one processor, in the case of the apparatus 220 configured as a computing network entity, rather than as a processor. The processor 240, in such case, may be in operative communication with the components 222-234 via a bus 242 or similar communication coupling. The processor 240 may effect initiation and scheduling of the processes or functions performed by electrical components 222-234.

In further related aspects, the apparatus 220 may include a communication component 244 (e.g., an Ethernet interface module, radio transceiver module, etc.). The apparatus 220 may optionally include a component for storing information, such as, for example, a memory device/component 246. The computer readable medium or the memory component 246 may be operatively coupled to the other components of the apparatus 200 via the bus 242 or the like. The memory component 246 may be adapted to store computer readable instructions and data for effecting the processes and behavior of the components 222-234, and subcomponents thereof, or the processor 240, or the methods disclosed herein. The memory component 246 may retain instructions for executing functions associated with the components 222-234. While shown as being external to the memory 246, it is to be understood that the components 222-234 can exist within the memory 246.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes Compact Disc (CD), laser disc, optical disc, Digital Versatile Disc (DVD), floppy disk and Blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method, comprising:
receiving at least one row metadata;
receiving at least one column metadata;
associating cells at an intersection of at least one row containing the at least one row metadata and at least one column containing the at least one column metadata into a set; and
assigning at least one property for the set.

2. The method of claim 1, wherein assigning the at least one property comprises assigning a formatting attribute to each cell of the set.

3. The method of claim 1, wherein assigning the at least one property comprises assigning same content to each cell of the set.

4. The method of claim 3, where the content comprises at least one of a formula, a numerical value, and a string.

5. The method of claim 1, further comprising, in response to a user changing the at least one property in any cell of the set, applying the changed at least one property to each cell of the set.

6. The method of claim 5, wherein the at least one property comprises at least one of content and formatting.

7. The method of claim 1, wherein the at least one row metadata comprises at least one of a keyword, a tag, a label, and a row hierarchical position.

8. The method of claim 7, wherein the row hierarchical position comprises at least one of parent status, child status, sibling status, and descendant status, relative to at least one other row of the spreadsheet.

9. The method of claim 1, wherein the at least one column metadata comprises at least one of a keyword, a tag, a label, and a column hierarchical position.

10. The method of claim 9, wherein the column hierarchical position comprises at least one of parent status, child status, sibling status, and descendant status, relative to at least one other column of the spreadsheet.

11. An apparatus, comprising:
at least one processor for executing computer executable instructions; and
at least one memory in operative communication with the at least one processor and storing computer executable instructions for:
receiving at least one row metadata;
receiving at least one column metadata;
associating cells at an intersection of at least one row containing the at least one row metadata and at least one column containing the at least one column metadata into a set; and
assigning at least one property for the set.

12. The apparatus of claim 11, wherein the at least one processor assigns the at least one property by assigning a formatting attribute to each cell of the set.

13. The apparatus of claim 11, wherein the at least one processor assigns the at least one property by assigning same content to each cell of the set.

14. The apparatus of claim 13, where the content comprises at least one of a formula, a numerical value, and a string.

15. The apparatus of claim 11, wherein the at least one processor, in response to a user changing the at least one property in any cell of the set, applies the changed at least one property to each cell of the set.

16. The apparatus of claim 15, wherein the at least one property comprises at least one of content and formatting.

17. The apparatus of claim 11, wherein the at least one row metadata comprises at least one of a keyword, a tag, a label, and a row hierarchical position.

18. The apparatus of claim 17, wherein the row hierarchical position comprises at least one of parent status, child status, sibling status, and descendant status, relative to at least one other row of the spreadsheet.

19. The apparatus of claim 11, wherein the at least one column metadata comprises at least one of a keyword, a tag, a label, and a column hierarchical position.

20. The apparatus of claim 19, wherein the column hierarchical position comprises at least one of parent status, child status, sibling status, and descendant status, relative to at least one other column of the spreadsheet.

21. A computer program product, comprising:
a computer-readable medium comprising code for causing a computer to:
receive at least one row metadata;
receive at least one column metadata;
associate cells at an intersection of at least one row containing the at least one row metadata and at least one column containing the at least one column metadata into a set; and
assign at least one property for the set.

22. The computer program product of claim 21, wherein the computer-readable medium further comprises code for causing the computer to assign the at least one property by assigning a formatting attribute to each cell of the set.

23. The computer program product of claim 21, wherein the computer-readable medium further comprises code for causing the computer to assign the at least one property by assigning same content to each cell of the set.
